(19) United States
(12) Patent Application Publication
(10) Pub. No.: US 2017/0301027 A1
(43) Pub. Date: Oct. 19, 2017

(54) ROLE BASED ASSET ALLOCATION STRUCTURE AND MODEL

(71) Applicant: AMERIPRISE FINANCIAL, INC., MINNEAPOLIS, MN (US)

(72) Inventors: Jay Untiedt, Independence, MN (US); Craig Brimhall, Grottoes, VA (US); Michael Victor Jastrow, Minneapolis, MN (US); Lyle Ben Schonberger, Troy, MI (US); Steven Soranno, Bloomfield Hills, MI (US)

(21) Appl. No.: 15/456,516

(22) Filed: Mar. 11, 2017

Related U.S. Application Data
(60) Provisional application No. 62/307,337, filed on Mar. 11, 2016.

(51) Int. Cl. G06Q 40/06; G06Q 40/04; G06Q 40/02

(52) U.S. Cl. CPC G06Q 40/06; G06Q 40/02; G06Q 40/04

(57) ABSTRACT

An apparatus includes a processor, a network interface, a display device, and am memory. The memory stores instructions that, when executed by the processor, cause the processor to perform operations including, based on profile data received via the network interface, generating a portfolio data structure. The portfolio data structure identifies a plurality of asset classes and an allocation of funds between the asset classes, where a particular asset class of the plurality of asset classes includes a first product of a first product type and a second product of a second product type. The operations further include, based on the portfolio data structure, sending a message, via the network interface, to initiate a transaction at a device associated with a financial institution. The operations further include initiating display of a graphical user interface at the display device based on the portfolio data structure.

### I. CLAIM OF PRIORITY

This application claims priority from U.S. Provisional Patent Application Ser. No. 62/307,337 filed on Mar. 11, 2016, which is incorporated herein by reference in its entirety.

### II. BACKGROUND

Most investment portfolios mainly consist of equity, debt, and cash components. Many individuals invest funds in investment portfolios to increase or protect their wealth. Funds in an investment portfolio may be allocated between asset classes based on an allocation model. The asset classes may be defined by an asset class structure. Each asset class may include products of a single product type that defines the asset class. Examples of asset classes include an equity class, a cash class, and a debt class. Products included in the equity asset class may all have an equity product type. To illustrate, the equity asset class may be associated with stocks, mutual funds, and other securities exposed to equity markets.

In order to achieve the highest yield from an investment portfolio, risks (e.g., market fluctuations) may be ignored when determining an allocation model by which to allocate investment funds among the various asset classes. Ignoring risks may lead to decline in value of the investment portfolio during downside market conditions. Moreover, investment portfolios that are more focused towards return on investment and/or yield may underestimate the importance of managing longer life expectancy and hedging the impact of inflation. The traditionally known one to one mapping of asset classes to one product type may lead to over exposure or under exposure to one asset class increasing a risk of high loss during downside market conditions. The one to one mapping arrangement may also impede income generation, such as during downside market conditions. Asset class structures having a mapping of asset classes to a single product type may be too conservative to different investment risks or may be over exposed to the investment risks. The allocation of only one product type into one asset class may also lead to delayed corrective measures during financial market fluctuations, for example due to a sudden increase or decrease in the value of an investment portfolios designed based on the traditional asset allocation models. Such methods and systems may thus fail to safeguard retirement portfolios against sudden erosion during adverse financial market conditions.

Funds may be allocated among the asset classes of an investment portfolio in order to meet a goal. For example, in order to achieve growth, more funds may be invested in the equity asset class. Conversely, in order to protect established wealth, more funds may be invested in the debt asset class. Allocating funds between classes defined by product types may not account for market factors such as inflation, market fluctuations along with capital growth and income protection. Accordingly, an investor who allocates funds between classes defined by a single product type each may not be able to timely achieve or his or her financial goals.

### III. SUMMARY

According to the present disclosure, an asset class structure may define asset classes based on “roles” rather than product type. As used herein, a role may refer to a role an asset class is to perform in an investment portfolio. Role based asset classes may include a capital growth class, a risk management asset class, an inflation hedging asset class and an income production asset class. The role of the capital growth asset class may be to increase capital through asset appreciation or dividend payouts. The role of the income production asset class may be to provide stability to the portfolio by generating with high levels of predictable income, which does not vary across market environments. The role of the inflation hedging asset class may be to protect against the risk of unexpected inflation. The inflation hedging asset class may include products of various product types, such as inflation protected bonds, infrastructure investments, or real estate investments. The role of the risk management asset class may be to limit market risk to the investment portfolio. Since the asset classes are defined based on roles, an asset class may include products of more than one product type. To illustrate, products like mutual funds, government bonds and certificate deposits may be included in one role based asset class, such as a capital growth asset class. Further, different asset classes may include products of the same product type. Including more than one type of product in an asset class may protect against sudden erosion of funds.

Further, according to the present disclosure, funds of an overall investment portfolio may be segregated into three portfolios. The three portfolios may include a long term investment portfolio, a medium term investment portfolio and a near term investment portfolio. The long term investment portfolio may be associated with a highest risk portion of the overall investment portfolio. For example, thirty five percent to fifty percent of funds allocated to the long term investment portfolio may be allocated to the capital growth asset class. The capital growth asset class may be associated with ten to thirty percent returns. The medium term investment portfolio may be focused on income production and may be associated with a moderate risk. For example, five percent to twenty five percent of funds allocated to the medium term investment portfolio may be allocated to the capital growth asset class. The near term investment portfolio may be structured to meet cash flow needs by including investments that allow for regular withdrawals.

Each of the long term investment portfolio, the medium term investment portfolio, and the near term investment portfolio may be generated based on corresponding investment portfolio options. The investment portfolio options may be structured based on the role based asset class model. The investment portfolio options used to generate the long term investment portfolio, the medium term investment portfolio, and the near term investment portfolio may be determined based on simulations under different historical conditions. Further, in response to a change in any of a client's investment related parameters, systems and methods according to the disclosure may cause reallocation of at least a portion of the client's funds among the long term investment portfolio, the medium term investment portfolio, and the near term investment portfolio. Examples of investment related parameters include age, marital status, gender of the contract holder, and those of the beneficiary, details relating to the assets and liabilities, information relating to the number of dependents, financial goals, and their priority in terms of dollar value and timing, anticipated expenses, anticipated income, anticipated large expenditures such as educational expenses, buying a house, annual travel budget, account beginning balance, retirement start date, rate of inflation, preferred retirement income distribution strategy, periodic distribution rate, average annualized return from investment and variation in inflation.

Further, systems and methods according to the disclosure may enable changes to asset allocation model of individual portfolios (e.g., the long term investment portfolio, the medium term investment portfolio, and the near term investment portfolio), an asset class structure of individual portfolios and selected product types of individual portfolios based on changes to investment related parameters.

### IV. BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and components.

FIG. 1 illustrates an exemplary block diagram of the functional architecture for the system and method of the present invention.

FIGS. 2A and 2B illustrate exemplary flow diagrams, which represent the automated operational steps of the retirement plan generator system and method as per one aspect of the present invention.

FIGS. 3A, 3B, 3C and 3D illustrate embodiments for various retirement portfolios.

FIG. 4 illustrates an exemplary block diagram of the machine actuating the retirement plan generator system and method of the present invention as illustrated in FIGS. 1 & 2A-2B.

### V. DETAILED DESCRIPTION

Asset class structures in which one product type is part of one asset class mainly focus on either income protection or income growth. The growth or protection focus may lead to asset class structures suggesting either more exposure to equity or debt, respectively. Thus, during upside financial market conditions with a traditional asset class structure, there may be a sudden increase in the value of the investment portfolio. However, during downside market conditions, it may be challenging to restrict the sudden decrease in the value of retirement portfolio. The lack of focus towards factors such as inflation, market fluctuations along with capital growth and income protection may leads to clients not being able to timely achieve or completely miss their financial goals. The one to one mapping in asset allocation models may also suffer from the risk of clients living beyond the availability of funds due to erosion of funds, inflation, increased withdrawals and the like. It may thus be imperative to safeguard investment portfolios from factors such as market fluctuations and inflation, while also achieving growth in capital. Accordingly, the present invention describes an asset class structure generator method and system based on factors such as capital growth, income protection, inflation hedging and market risks.

The present disclosure relates to a system and method that safeguards portfolio investments from factors such as market risks, inflation and yet provides for income production and capital growth. More specifically the system and method provides for a new methodology of generating an asset class structure in which each asset class is generated considering the role that the asset class needs to play. The traditional asset class structure includes asset classes such as stocks, bonds, cash and alternatives. The role based asset classes include but not limited to capital growth, inflation hedging, risk management, and income production. The role based asset classes provide for one asset class containing multiple product types in order to meet the objectives of a role such as market risk management. The traditional asset classes generally have one product type mapped to one asset class that in scenarios of market fluctuations leads to sudden erosion of funds especially in case of downside market conditions. For example, in case of a traditional asset class structure, the equity based asset class only contains equity related product types such as mutual funds and stocks. In case of market fluctuations, the value of the investments parked under equity based asset class fluctuates thus destabilizing the investment objectives of the client. The traditional asset class structures are primarily defined to either grow investments or conserve or protect the investments. However, the asset class structures are never defined to manage the factors that impact the performance of the asset class structures. The factors in this case are nothing but the roles such as income production, inflation hedging, capital growth, and risk management. Thus, the present method and system focuses on developing an asset class structure generator that includes generating a role based asset class structure which provides for attainment of investment objectives by better management of above-mentioned factors. The defined method and system not only focuses on growth of invested funds but also focuses on better management of factors impacting the performance of asset class structures and thereby the investment portfolios. Secondly, the disclosed method and system provides for generation of more than one investment portfolio option devised on the new asset class structure to better manage long term, medium term and near term investments. The investment portfolios are selected based on the performance of each of the portfolios in a simulated environment. The performance of the portfolio is assessed based on varying retirement related parameters which include but are not limited to age, marital status, gender of the contract holder, and those of the beneficiary, details relating to the assets and liabilities, information relating to the number of dependents, financial goals, and their priority in terms of dollar value and timing, anticipated expenses, anticipated income, anticipated large expenditures such as educational expenses, buying a house, annual travel budget, account beginning balance, retirement start date, rate of inflation, preferred retirement income distribution strategy, periodic distribution rate, average annualized return from investment and variation in inflation.

The disclosed system and method provides for a novel and non-obvious approach to defining role based asset class structure allowing more than one product type to be part of multiple asset classes unlike traditional one to one mapping of product types to asset classes. The aspects of described systems and methods for generating a retirement plan disclosed below are structured on asset allocation models having asset classes based on the factors that impact the performance of the underlying investments and can be implemented on any electronic device including but not limited to low end cellular devices, pagers, smartphones, computers, servers, and or any other device having processing, receiving and transmitting capabilities. The disclosed system and method is described in the context of the following exemplary system(s) and method(s).

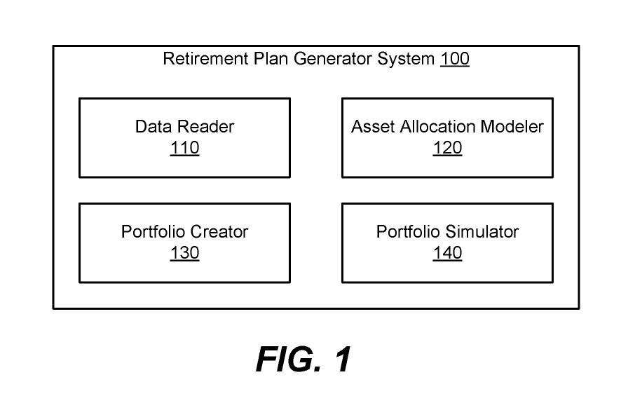

FIG. 1 illustrates the block diagram of the functional architecture of the system and method for generating an asset class structure. In one embodiment, the functional architecture of the asset class structure generator system 100 contains a data reader 110, which extracts profile data from at least one data reader server. In one embodiment, the data reader server housing the profile data is remotely connected to the asset class structure generator system 100 via a network. The profile data includes, but need not be limited to age, marital status, gender of the contract holder, and those of the beneficiary, details relating to the assets and liabilities, information relating to the number of dependents, financial goals, and their priority in terms of dollar value and timing, anticipated expenses, anticipated income, anticipated large expenditures such as educational expenses, buying a house, annual travel budget, account beginning balance, retirement start date, rate of inflation, preferred retirement income distribution strategy, periodic distribution rate, average annualized return from investment and variation in inflation. Data that provides any direct and/or indirect information about client can be deemed as profile data.

In one embodiment, the data reader 110 also provides for evaluation of profile data of the clients. The data reader 110 basis evaluation of client profile data provides for selection of appropriate periodic distribution rate from the distribution rate table managed by the data reader server. The periodic distribution rate is the minimum amount of funds that the client should withdraw post retirement at predetermined intervals, in order to meet the client requirements. The data reader server manages multiple periodic distribution rates computed on the basis of parameters including but not limited to expected distribution rate, inflation rate, preferred distribution strategy, expected retirement period, wrap fee and risk tolerance. The periodic distribution rates are populated in the distribution rate table. Up on evaluating the profile data, the data reader 110 identifies the matching profile in the distribution rate table and fetches the corresponding periodic distribution rate. For unique data with no match found, the data reader 110 computes the periodic distribution rate and populates the newly computed periodic distribution rate in correspondence to the client profile data in the distribution rate table managed by the data reader server.

In one embodiment, the asset class structure generator system 100 includes asset allocation modeler 120 that generates asset allocation models having role based asset class structure. The asset class structure is generated based on supplied client profile data and defined periodic distribution rate. The roles for defining the asset class structure include but need not be limited to capital growth, inflation hedging, income production and market risk management. The roles are nothing but factors that impact the performance of asset allocation models and its underlying portfolios.

The asset allocation modeler 120 is connected to various databases/systems/servers of third party financial institutions, banking and non-banking financial organizations, financial planning organizations, financial advisor blogs, finance-based web portals and any networked medium providing direct and/or indirect information on financial products and/or financial market sector performance and other data. In one embodiment, the database is an internal database maintaining the details of the available product types.

The asset allocation modeler 120 identifies the mix of roles for each of the investment portfolio option generated by the portfolio creator 130. The identification of role mix is nothing but percentage distribution of client's retirement funds into each of defined roles.

The asset allocation modeler 120 actuates the percentage distribution of funds under each role. The percentage distribution of funds primarily depends up on including but not limited to the target periodic distribution rate and the evaluated client profile data.

In one embodiment, the asset class structure generator system 100 includes portfolio creator 130 that generates multiple portfolio options which are structured on the role based asset allocation structure. At least one portfolio option is generated by the portfolio creator 130 to manage each of long term, medium term and near term investments.

The portfolio for managing long term risk returns investments includes more of investments into including but not limited to capital growth asset class (0%-35%), income production asset class (0%-40%), risk management asset class (0%-35%) and inflation hedging asset class (0%-35%). The percentage distribution of funds into individual role based asset classes of the long term retirement portfolio depends on the expected investment return target, volatility target, and distribution yield target. The retirement portfolio for managing medium term risk returns investments includes more of investments into including but not limited to capital growth asset class (0%-20%), income production asset class (0%-50%), risk management asset class (0%-45%) and inflation hedging asset class (0%-25%). The percentage distribution of funds into individual role based asset classes of the medium term retirement portfolio option depends on the expected investment return target, volatility target, and distribution yield target. The retirement portfolio option for managing near term risk returns investments includes more of investments into including but not limited to risk management asset class (0%-50%) and inflation hedging asset class (0%-50%) such as checking account, savings account, certificate deposits, and money market funds. The near term retirement portfolio options are set up to meet the immediate needs of funds of a client. For example, in case the client is in need of funds and wants to withdraw funds from his/her portfolio, the system and method firstly provides for withdrawal of funds from the near term portfolio option. The funds are transferred from long term or medium term portfolio to near term portfolio on need basis to maintain immediate availability of funds and secure the funds from sudden erosion or market fluctuations.

The asset allocation modeler 120 evaluates the product types and rates each product type on a risk scale of one (1) to ten (10) with one being the lowest and ten being the highest. Other scale increments and boundaries may be substituted for risk assessment of the product types. In one embodiment, the measuring unit to evaluate the risk of each product type can be alpha numeric, alphabetic and the like. The percentage allocation of funds into individual product types depends on the rating provided by the risk scale for the various product types. The risk scale is defined by parameters that include, but need not be limited to, return on investment of a product type for a specific time period, sustainability of a particular product type under dynamic market scenarios, and/or amount of volatility experienced by the various product types in a defined time period. The performance of a particular product type for a specific time period is determined based on the relative comparison of that particular product type with the rest of the product types forming part of an asset class. The performance can be ascertained on rate of return on the invested amount, keeping in check the relative product type volatility, and/or sustainability of a particular product type during dynamic market conditions. For example, product type A provides ten percent (10%) annual rate of return on a given amount of $1,000, and product type B provides eight-and-a-half percent (8.5%) annual rate of return; however, in the last year, product type A has experienced more volatility in comparison to product type B; moreover, product type B has experienced more sustainability during the given time period than product type A. Therefore, the risk scale based on comprehensive interrelated analysis of mentioned parameters formulates a rating of seven (7) to product type B and a rating of six (6) to product type A. Since, product type B has a better risk scale rating of seven (7) and provides for less financial risk for the client, therefore, more client funds are allocated to product type B in comparison to product type A.

In one embodiment, the asset class structure generator system 100 includes portfolio simulator 140 that tests the performance of the portfolio options generated by the portfolio creator 130, by carrying out simulations in multiple market conditions. The simulations are performed based on varying parameters such as age, marital status, gender of the contract holder, and those of the beneficiary, details relating to the assets and liabilities, information relating to the number of dependents, financial goals, and their priority in terms of dollar value and timing, anticipated expenses, anticipated income, anticipated large expenditures such as educational expenses, buying a house, annual travel budget, account beginning balance, retirement start date, rate of inflation, preferred retirement income distribution strategy, periodic distribution rate, average annualized return from investment and variation in inflation.

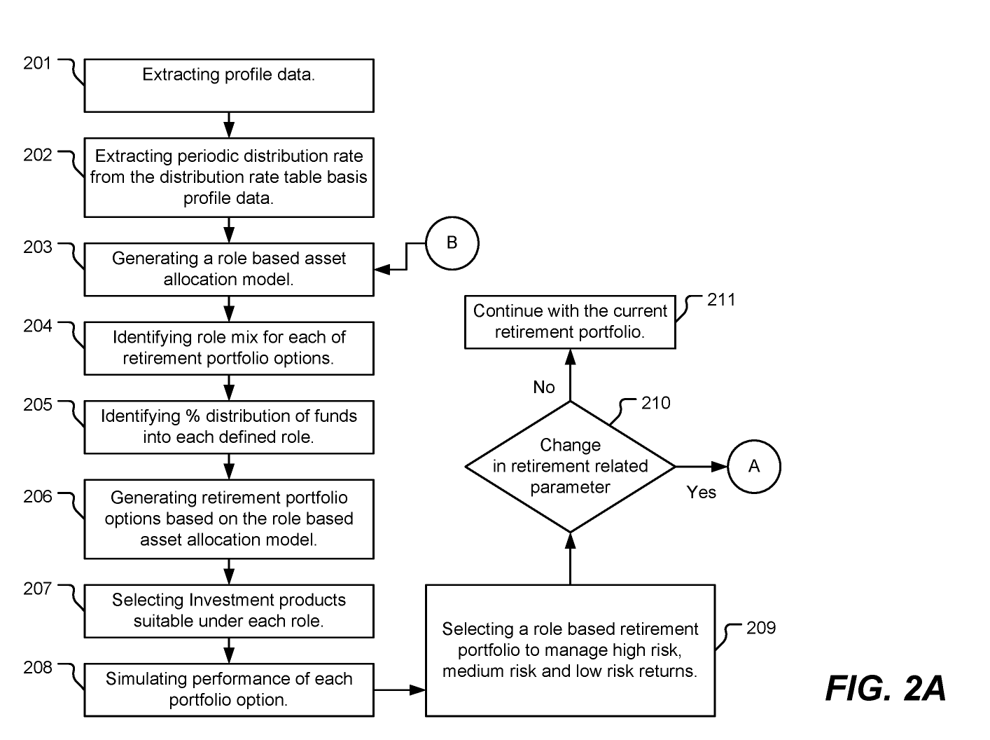

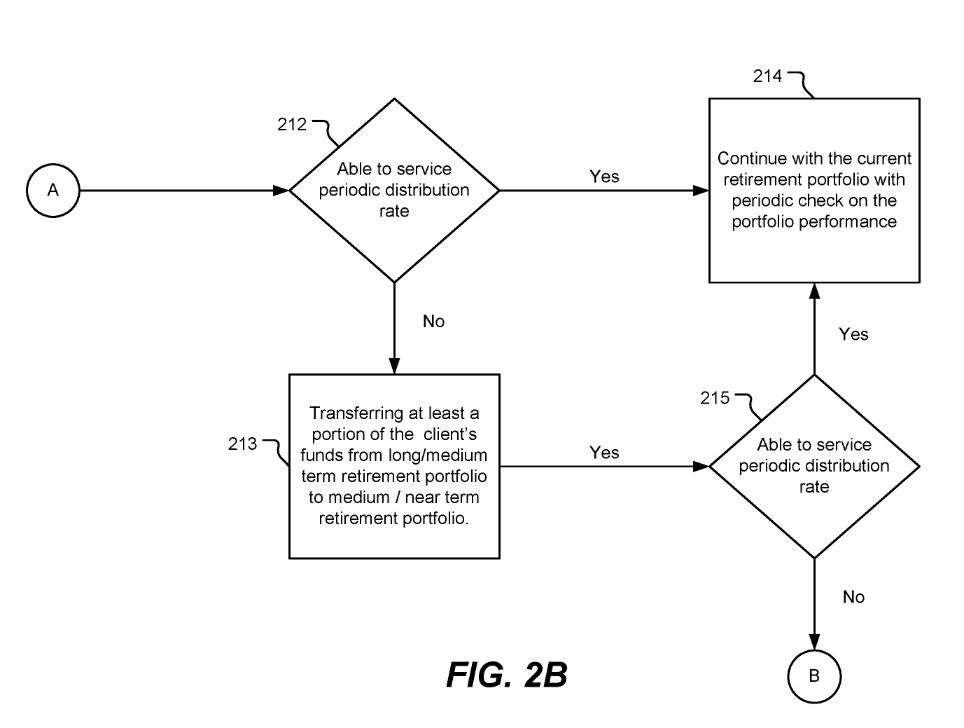

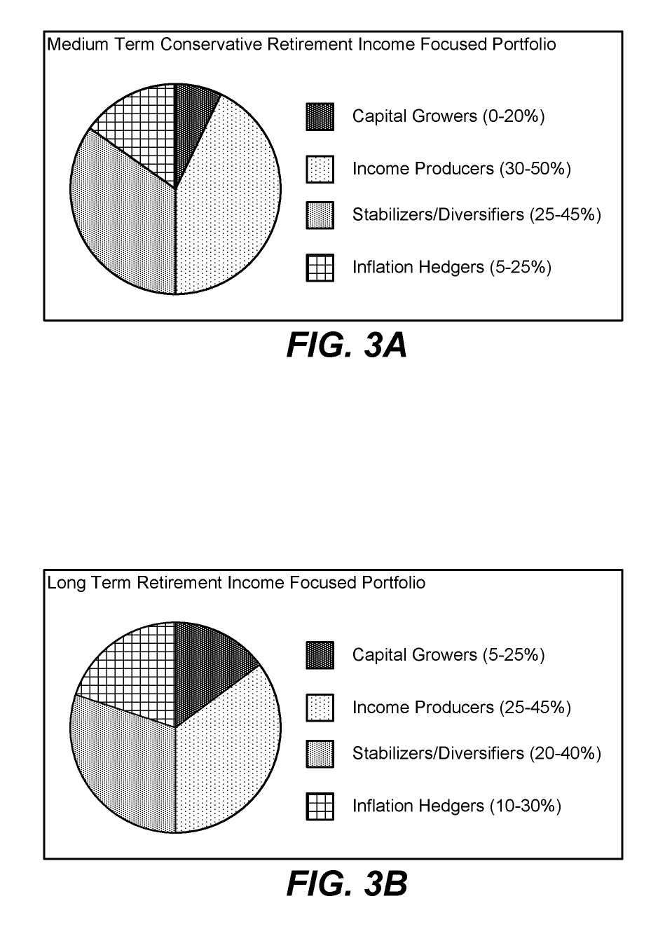

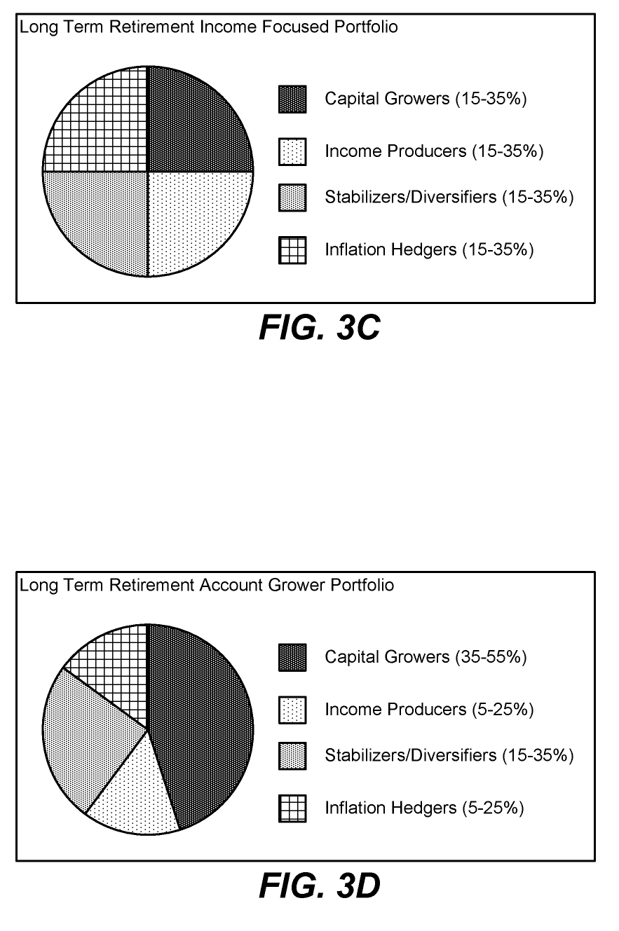

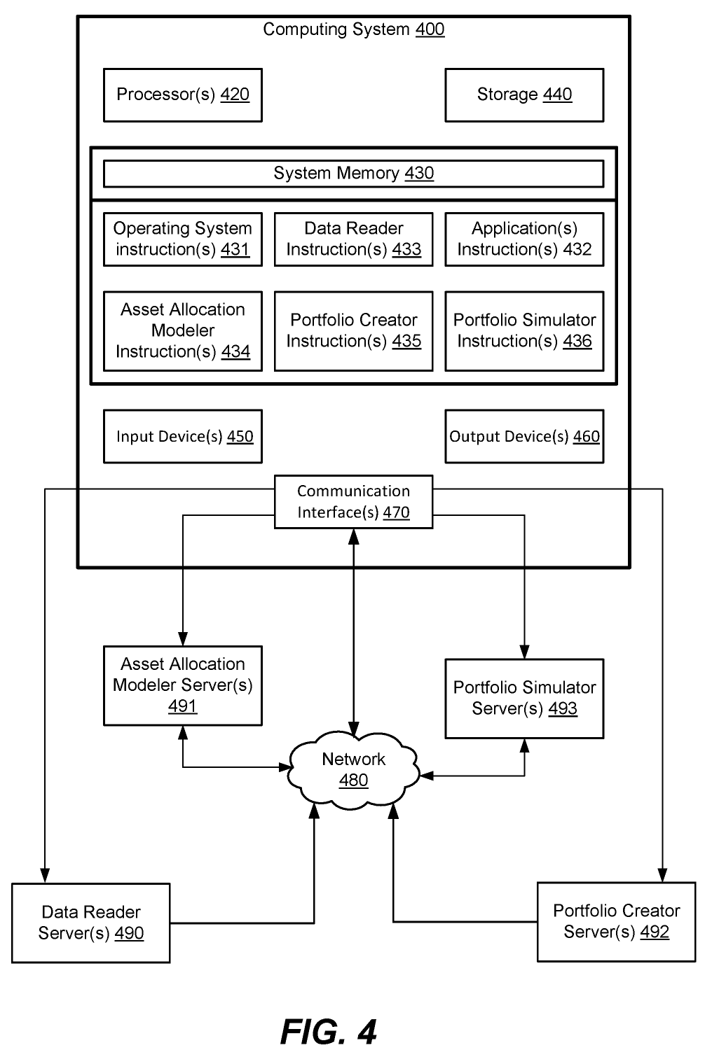

FIGS. 2A and 2B illustrate the flow diagram which represents the automated operational steps of the asset class structure generator system 100. The automated operational steps will be described with references to the devices, modules, systems, examples and/or architecture described in FIG. 1, FIG. 3A, FIG. 3B, FIG. 3C, FIG. 3D and FIG. 4.

In one embodiment, the automated operational steps of the asset class structure generator system can be implemented on any electronic device including but not limited to low end cellular devices, pagers, smartphones, computers, servers, and or any other device having processing, receiving and transmitting capabilities. The automated operational steps of the asset class structure generator system begin with extraction of the profile data by the data reader 110 of the asset class structure generator system 100 at block 201. The profile data includes, but need not be limited to, age, marital status, gender of the contract holder, and those of the beneficiary, details relating to the assets and liabilities, information relating to the number of dependents, financial goals, and their priority in terms of dollar value and timing, anticipated expenses, anticipated income, anticipated large expenditures such as educational expenses, buying a house, annual travel budget, account beginning balance, retirement start date, rate of inflation, preferred retirement income distribution strategy, projected expenses and the like.

At block 202, the data reader 110 of the asset class structure generator system 100 assesses the profile data of at least one client. The data reader 110 basis evaluation of client profile data provides for selection of appropriate periodic distribution rate from the distribution rate table managed by the data reader server. The periodic distribution rate is the minimum amount of funds that the client should withdraw post retirement at predetermined intervals, in order to meet the requirements. The distribution rate table contains multiple periodic distribution rates to client profile mappings and provides for appropriate selection of periodic distribution rate basis the evaluation of client profile. In one embodiment, the client profile data is similar to at least one record in the distribution rate table. The data reader 110 fetches the corresponding periodic distribution rate for the client. In another embodiment, the client profile data does not match with any record in the distribution rate table. The data reader 110 calculates the periodic distribution rate for the client and updates/populates the newly computed periodic distribution rate in correspondence to the client profile data in the distribution rate table managed by the data reader server.

At block 203, the asset allocation modeler 120 of the asset class structure generator system 100, based on the profile data and periodic retirement distribution rate, generates an asset allocation model having at least one role based asset class structure. The defined asset class structure is role based rather than the traditional asset class structure. The traditional asset class structure includes asset classes such as stocks, bonds, cash and alternatives. The role based asset classes include but not limited to capital growth, inflation hedging, risk management, and income production. The role based asset classes provide for one asset class containing multiple product types in order to meet the objectives of a role such as market risk management. The traditional asset classes generally have one product type mapped to one asset class that in scenarios of market fluctuations leads to sudden erosion of funds especially in case of downside market conditions. For example, in case of a traditional asset class structure, the equity based asset class only contains equity related product types such as mutual funds and stocks. In case of market fluctuations, the value of the investments parked under equity based asset class fluctuates thus destabilizing the investment goals of the client. The traditional asset class structures are primarily structured to either grow investments or conserve or protect the investments. However, the asset allocation models are never structured to manage the factors that impact the performance of the asset allocation model. The factors in this case are nothing but the roles such as income production, inflation hedging, capital growth, and risk management. Thus, the present method and system focuses on developing a retirement plan generator system that includes a role based asset allocation model which provides for attainment of retirement goals by focused management of above-mentioned factors. The defined method and system not only focuses on growth of the invested funds into retirement portfolio but also focuses on better management of factors impacting the performance of asset allocation models.

At block 204, asset allocation modeler 120 of the asset class structure generator system 100, identifies the mix of roles for each of the portfolio option generated by the portfolio creator 130. The identification of role mix is nothing but percentage distribution of funds into each of defined roles.

At block 205, asset allocation modeler 120 actuates the percentage distribution of client's funds under each role. The percentage distribution of funds primarily depends upon including but not limited to the target periodic distribution rate and the evaluated client profile data.

The asset allocation modeler 120 identifies role mix for at least one portfolio option generated to manage each of long term, medium term and near term risk return investments. The portfolio for managing long term risk return investments includes more of investments into including but not limited to capital growth asset class (0%-35%), income production asset class (0%-40%), risk management asset class (0%-35%) and inflation hedging asset class (0%-35%). The percentage distribution of funds into individual role based asset classes of the long term portfolio option depends on the expected investment return target, volatility target, and distribution yield target. The portfolio for managing medium term risk return investments includes more of investments into including but not limited to capital growth asset class (0%-20%), income production asset class (0%-50%), risk management asset class (0%-45%) and inflation hedging asset class (0%-25%). The percentage distribution of funds into individual role based asset classes of the medium term risk return portfolio option depends on the expected investment return target, volatility target, and distribution yield target. The portfolio option for managing near term risk return investments includes more of investments into including but not limited to risk management asset class (0%-50%) and inflation hedging asset class (0%-50%) such as checking account, savings account, certificate deposits, and money market funds. The near term retirement portfolio option is set up to meet the immediate needs of funds of a client. For example, in case the client is in need of funds and wants to withdraw funds from his/her retirement portfolio, the system and method firstly provides for withdrawal of funds from the near term retirement portfolio option. The funds are transferred from long term or medium term retirement portfolio to near term retirement portfolio on need basis to maintain immediate availability of funds and secure the funds from sudden erosion or market fluctuations. In another embodiment, the time period or numbers of years to be defined as long term, medium term and near term, is determined by the data reader 110 of system 100 based on the inputs received from the client.

In an exemplary scenario, the asset allocation modeler 120 identifies role mix based portfolio options to manage each of the long term, medium term and near term risk return investments. In one embodiment, FIG. 3A illustrates the distribution of the allocated fifty percent of the client's fund in a medium term portfolio option. Up to twenty percent of the allocated fifty percent fund is allocated into capital growth asset class, thirty percent to fifty percent of the allocated fifty percent fund is allocated into income production asset class, twenty five percent to forty five percent of the allocated fifty percent is allocated into risk management asset class and five percent (5%) to twenty five percent of the allocated fifty percent is allocated into inflation hedging asset class.

FIG. 3B illustrates the distribution of the allocated thirty percent of the fund in the long term portfolio option focused on income production. Five percent (5%) to twenty five percent of the allocated thirty percent retirement fund is allocated into capital growth asset class, twenty five percent to forty five percent of the allocated thirty percent retirement fund is allocated into income production asset class, twenty to forty percent of the allocated thirty percent retirement fund is allocated into risk management asset class and ten percent (10%) to thirty percent of the allocated thirty percent is allocated into inflation hedging asset class.

At block 206, the portfolio creator 130 generates at least one portfolio option devised on the new role based asset class structure to better manage near term, medium term, and long term risk return investments.

At block 207, the asset allocation modeler 120 identifies the product types that would be part of each of the role based asset class forming part of the role based asset class structure. The asset allocation modeler 120 maps the product types to each of the role based asset classes. These roles include but need not be limited to capital growth, inflation hedging, risk management and income production. The role of the capital growth asset class within the portfolio is to grow capital through dividend increases and asset price appreciation. In one embodiment, domestic and international equity based products such as stocks are part of capital growth asset class. Capital growth asset class primarily houses product types that are more reactive to market fluctuations and provide for long term growth to client investments. Product types tagged to the role of inflation hedging have built-in mechanisms to protect against unexpected inflation. These can include but not limited to investments that have contractual terms that mandate increases in asset values and/or cash flows tied to inflation measures (such as inflation protected bonds, infrastructure, or real estate investments), product types that usually rise in value when inflation occurs (commodities or precious metals), or product types that increase with short-term′ interest rates, which generally rise when inflation increases (floating rate bank loans). In one embodiment, equities can also be considered for inflation hedging over the long-term, as corporate earnings increase over time. Over the short-term, though, the link between inflation and equity prices can be weak. These product types provide for security from the risk of outliving your investments. Product types mapped to the role of income production are used in the portfolio to generate current income including but not limited to interest payments, dividends, or other structured payments (like premiums received from selling call options in a covered call strategy). In one embodiment, the best income production product type would generate high levels of predictable income, which would not vary across market environments. Product types that help the clients limit their market risk are tagged with the role of risk management. Such product types would include but need not be limited to assets that hold their value regardless of the market environment (such as savings account, current account, certificate deposits, and debt bonds among others); assets that generally remain stable in value when other parts of the portfolio are declining (such as long-term government bonds, volatility-linked strategies, and managed futures) and assets that introduce uncorrelated sources of return and increase portfolio diversification (such as hedge funds).

In one embodiment at block 207, the asset allocation modeler 120 evaluates the product types and rates each product type on a risk scale of one (1) to ten (10) with one being the lowest and ten being the highest. Other scale increments and boundaries may be substituted for risk assessment of the product types. In one embodiment, the measuring unit to evaluate the risk of each product type can be alpha numeric, alphabetic and the like. The percentage allocation of funds into individual product types depends on the rating provided by the risk scale for the various product types. The risk scale is defined by parameters that include, but need not be limited to, return on investment of a product type for a specific time period, sustainability of a particular product type under dynamic market scenarios, and/or amount of volatility experienced by the various product types in a defined time period. The performance of a particular product type for a specific time period is determined based on the relative comparison of that particular product type with the rest of the product types forming part of an asset class. The performance can be ascertained on rate of return on the invested amount, keeping in check the relative product type volatility, and/or sustainability of a particular product type during dynamic market conditions. For example, product type A provides ten percent (10%) annual rate of return on a given amount of $1,000, and product type B provides eight-and-a-half percent (8.5%) annual rate of return; however, in the last year, product type A has experienced more volatility in comparison to product type B; moreover, product type B has experienced more sustainability during the given time period than product type A. Therefore, the risk scale based on comprehensive interrelated analysis of mentioned parameters formulates a rating of seven (7) to product type B and a rating of six (6) to product type A. Since, product type B has a better risk scale rating of seven (7) and provides for less financial risk for the client, therefore, more client funds are allocated to product type B in comparison to product type A.

In one embodiment, U.S. large cap equities have multiple roles to play but may not be tagged to some roles at all. U.S. large cap equities can be a part of income production asset class, capital growth asset class and to some extent inflation hedging asset class but the same cannot be tagged to the role of risk management asset class. Similarly, in one embodiment, cash, savings account, current account, certificate deposits, and debt bonds have multiple roles to play but may not be tagged to some roles at all. Savings account, current account, certificate deposits, and debt bonds cash can play a role in risk management and to some extent it can be part of inflation hedging asset class and income production asset class but the same cannot be tagged to the role of capital growth asset class.

At block 207, the asset allocation modeler 120 also identifies the individual products in which the client funds are to be allocated as part of a particular role and product type. In an exemplary scenario, a long term portfolio option based on the role based asset class structure has forty five percent of the allocated fifty percent funds distributed under capital growth, twenty five percent of the allocated fifty percent funds under inflation hedging, and twenty percent of the allocated fifty percent funds under market risk management. In one embodiment, the asset allocation modeler 120 allows for identification of product types under each of the roles. In one embodiment, forty five percent of the funds under capital growth asset class are invested into derivatives, options, mutual funds, direct stocks and the like. In one embodiment, the asset allocation modeler 120 further allows for identification of individual products under each product type such as mutual funds. In one embodiment, the method and system is connected to the systems and networks of various broker dealers, financial product based companies such as Morgan Stanley, River Source, Lincoln Financial and the like. The asset allocation modeler 120 thus firstly provides for defining the percentage distribution of funds under each role, secondly identifies individual product types and lastly identifies respective products into which the client's funds are to be invested.

At block 208, the system simulator 140, simulates the performance of at least one asset class structure option generated by the portfolio creator 130. The performance of the portfolio option which is based on the asset class structure is assessed based on varying parameters which include but are not limited to age, marital status, gender of the contract holder, and those of the beneficiary, details relating to the assets and liabilities, information relating to the number of dependents, financial goals, and their priority in terms of dollar value and timing, anticipated expenses, anticipated income, anticipated large expenditures such as educational expenses, buying a house, annual travel budget, account beginning balance, retirement start date, rate of inflation, preferred retirement income distribution strategy, periodic distribution rate, average annualized return from investment and variation in inflation. In one embodiment, the system simulator 140, tests the performance of at least one portfolio option generated under each of the long term, medium term, and near term portfolio option.

At block 209, based on the results of the simulation and considering the selected distribution rate, and client profile data among others, the system simulator 140 selects at least one portfolio option under each of the long term, medium term and near term portfolio.

In one embodiment, at block 210, the data reader 110 captures if there is a fluctuation in the initial value of parameters which include but are not limited to age, marital status, gender of the contract holder, and those of the beneficiary, details relating to the assets and liabilities, information relating to the number of dependents, financial goals, and their priority in terms of dollar value and timing, anticipated expenses, anticipated income, anticipated large expenditures such as educational expenses, buying a house, annual travel budget, account beginning balance, retirement start date, rate of inflation, preferred retirement income distribution strategy, periodic distribution rate, average annualized return from investment and variation in inflation. The data reader 110 also captures any substantial erosion in the achieved fund value of the client's long term, medium term and immediate term risk return portfolio. The data reader 110 seeks for the percentage threshold value in respect of decline in fund value of client's various portfolio investments.

At block 211, the client continues with the current portfolio if there is no change in the set value of parameters which include but are not limited to age, marital status, gender of the contract holder, and those of the beneficiary, details relating to the assets and liabilities, information relating to the number of dependents, financial goals, and their priority in terms of dollar value and timing, anticipated expenses, anticipated income, anticipated large expenditures such as educational expenses, buying a house, annual travel budget, account beginning balance, retirement start date, rate of inflation, preferred retirement income distribution strategy, periodic distribution rate, average annualized return from investment and variation in inflation.

If there is any change in any of the retirement related parameters, the system simulator 140 assesses the impact of change on each of the long term, medium term and near term portfolio options. The system simulator 140 also assesses if with the change in parameters, market conditions and the like, whether the current percentage distribution of client funds into the long term, medium term and near term retirement portfolio option is able to service the periodic income distribution rate as illustrated in block 212. If with all the changes, the existing percentage distribution of client funds is able to service the periodic income distribution rate, then there is no change executed to the existing role based asset class structure and thereby no change to either the product type or individual products as illustrated in block 214.

At block 212, if there is any change in any of the retirement related parameters, the system simulator 140 assesses the impact of change on each of the long term, medium term and near term portfolio options. The system simulator 140 also assesses if with the change in parameters, market conditions and the like, the current percentage distribution of client funds into the long term, medium term and near term retirement portfolio option is able to service the periodic retirement income distribution rate. If with all the changes, the existing percentage distribution of client funds is not able to service the periodic distribution rate, then the client funds from initial long term and/or medium term portfolio is transferred to near term portfolio as illustrated in block 213.

At block 215, the system simulator 140 reassess if with the transfer of client funds within at least two of the three portfolios is able to provide for servicing of the periodic distribution rate. If the reassessment leads to non-servicing of periodic distribution rate then the portfolio simulator 140 actuates the asset allocation modeler to affect changes into the asset class structure, selected product type and/or product.

FIG. 3C illustrates an embodiment where the client has a balanced long term portfolio. There is an equal distribution of the fifty percent of funds allocated for investment into long term portfolio, into each asset class under long term balanced portfolio option. Fifteen percent to thirty five percent of the allocated fifty percent fund is allocated into capital growth asset class, fifteen percent to thirty five percent of the allocated fifty percent fund is allocated into income production asset class, fifteen percent to thirty five percent of the allocated fifty percent fund is allocated into risk management asset class and fifteen percent to thirty five percent of the allocated fifty percent fund is allocated into inflation hedging asset class.

FIG. 3D illustrates an embodiment where the client has a growth focused long term portfolio option. In an exemplary scenario, fifty percent of the retirement fund is allocated for investing into long term retirement portfolio. Thirty five percent to fifty five percent of the allocated fifty percent fund is allocated into capital growth asset class, five percent (5%) to twenty five percent of the allocated fifty percent retirement fund is allocated into income production asset class, fifteen percent to thirty five percent of the allocated fifty percent fund is allocated into risk management asset class and five percent (5%) to twenty five percent of the allocated fifty percent fund is allocated into inflation hedging asset class.

In one embodiment, the parameters include but are not limited to age, marital status, gender of the contract holder, and those of the beneficiary, details relating to the assets and liabilities, information relating to the number of dependents, financial goals, and their priority in terms of dollar value and timing, anticipated expenses, anticipated income, anticipated large expenditures such as educational expenses, buying a house, annual travel budget, account beginning balance, retirement start date, rate of inflation, preferred retirement income distribution strategy, periodic distribution rate, average annualized return from investment and variation in inflation.

FIG. 4 shows a block diagram of a computing system 400 including a representative electronic device 410 operable to support embodiments of system-implemented methods, system program products, and system components to implement the strategies, system-implemented methods, and rules as illustrated in FIGS. 1 & 2A-2B. In an illustrative embodiment, the electronic device 410 may implement one or more of the components of the asset class structure generator system 100 of FIG. 1.

The representative electronic device 410 includes at least one processor(s) 420, system memory 430, storage 440, input device(s) 450, output device(s) 460, communication interface(s) 470. The processor(s) 420 includes, for example, microprocessors, microcomputers, microcontrollers, digital signals processors, central processing units, state machines, logic circuitries, and/or any devices that manipulate data based on operational instructions. The processor(s) 420 can be configured to fetch and execute computer-program instructions stored in system memory 430. Generally, computer-program instructions can include routines, programs, objects, components, data structures, procedures, modules, functions, and the like that perform particular functions or implement particular abstract data types.

The system memory 430 may correspond to the asset class structure generator system 100 of FIG. 1. Depending on the configuration and type of the electronic device 410, the system memory 430 may be volatile (such as random access memory or “RAM”), non-volatile (such as read-only memory or “ROM,” and similar memory devices that maintain stored data even when power is not provided) or some combination of the two. In the embodiment illustrated in FIG. 4, the system memory 430 typically includes operating system instruction(s) 431, application(s) instruction(s) 432, data reader instruction(s) 433, asset allocation modeler instruction(s) 434, portfolio creator instruction(s) 435 and system simulator instruction(s) 436. The data reader instruction(s) 433 correspond to the data reader 110 of FIG. 1, the asset allocation modeler instruction(s) 434 correspond to asset allocation modeler 120 of FIG. 1, the portfolio creator instruction(s) 435 correspond to portfolio creator 130 of FIG. 1 and the system simulator instruction(s) 436 correspond to system simulator 140 of FIG. 1.

Processor(s) 420 fetches and executes computer program instructions from the applications instruction(s) 432. In one embodiment, the applications instruction(s) 432 receives the instructions for determination of periodic distribution rate from the data reader instruction(s) 433. The cumulative and interrelated functioning of the various instruction modules of the computing system 400 is enabled by the application(s) instruction(s) 432. Alternatively, the application(s) instruction(s) 432 may be located at multiple devices, where the multiple devices are part of a distributed system environment. In this case, one or more of the multiple devices of the distributed system may comprise the representative electronic device 410. In one embodiment, the application(s) instruction(s) 432 includes programs that supplement applications on any computing based device such as word processor applications, spreadsheet applications, and the like.

The electronic device 410 may also have additional features or functionality. In one embodiment, the electronic device 410 includes removable and/or non-removable data storage devices and servers including but not limited to magnetic disks, optical disks, tape, and memory cards. Such additional storage is illustrated in FIG. 4 by storage 440. System storage media may include volatile and/or non-volatile storage and removable and/or non-removable media implemented in any method or technology for storage of information such as system-readable instructions, data structures, program components or other data. The system memory 430 and the storage 440 are examples of system storage media. The system storage media includes, but need not be limited to, RAM, ROM, electrically erasable programmable read-only memory (EEPROM), or other memory technology, compact disks (CD), digital versatile disks (DVD) or other optical storage, magnetic cassettes, magnetic tape, magnetic disk storage or other magnetic storage devices, or any other tangible non-transitory medium that can be used to store information and that can be accessed by the electronic device 410. Any such system storage media may be part of the electronic device 410. The electronic device 410 may also have input device(s) 450, such as a keyboard, mouse, pen, voice input device, touch input device, etc. Output device(s) 460, such as a display, speakers, a printer, etc. may also be included.

In one embodiment, the storage 440, stores the data required for executing the operational steps of the system and method described in FIG. 1 and FIGS. 2A-2B. The storage 440 may include the data relating to the previous role mix, periodic distribution rate product type and products.

The electronic device 410 also includes one or more communication interface(s) 470 that allows the electronic device 410 to communicate with one or more data sources/databases. In one embodiment, the electronic device 410 communicates via a network 480 with various servers such as data reader server(s) 490, asset allocation modeler server(s) 491, portfolio creator server(s) 492, and system simulator server(s) 493. In the embodiment, the data resident on the data reader server(s) 490, asset allocation modeler server(s) 491, portfolio creator server(s) 492, system simulator server(s) 493 is locally accessible to the electronic device 410 via the respective instruction modules such as data reader instruction(s) 433, asset allocation modeler instruction(s) 434, portfolio creator instructions(s) 435, and system simulator instruction(s) 436.

In one embodiment, the electronic device 410 contains data reader instruction(s) 433, which when executed by the processor(s) 420 actuate extraction of the profile data by the data reader 110. The profile data includes, but need not be limited to, age, marital status, gender of the contract holder, and those of the beneficiary, details relating to the assets and liabilities, information relating to the number of dependents, financial goals, and their priority in terms of dollar value and timing, anticipated expenses, anticipated income, anticipated large expenditures such as educational expenses, buying a house, annual travel budget, account beginning balance, retirement start date, rate of inflation, preferred retirement income distribution strategy, projected expenses and the like.

The data reader instruction(s) 433 of the asset class structure generator system 100 actuates the data reader 110 to assess the profile data of at least one client. The data reader server(s) 490 houses the distribution rate table that contains multiple periodic distribution rates to client profile mappings and provides for appropriate selection of periodic distribution rate basis the evaluation of client profile by the data reader instruction(s) 433. In one embodiment, the client profile data is similar to at least one record in the distribution rate table. The data reader instruction(s) 433 actuates the command for fetching the corresponding periodic distribution rate from the data reader server(s) 490 for the client. In another embodiment, the client data does not match with any record in the distribution table housed within the data reader server(s) 490. The data reader instruction(s) 433 actuates the data reader server(s) 490 for computation of distribution rate based on the evaluation of client profile data. The calculated periodic distribution rate for the evaluated client profile data is updated/populated in the distribution rate table which is maintained within the data reader server(s) 490.

The asset allocation modeler instruction(s) 434 of the asset class structure generator system 100 based on the profile data and periodic distribution rate actuates the asset allocation modeler server(s) 491 for generation of an asset class structure having at least one role based asset class. The asset class structure has a role based asset class structure rather than the traditional asset class structure including asset classes such as stocks, bonds, cash and alternatives. The role based asset classes include but need not be limited to capital growth, inflation hedging, risk management, and income production. The role based asset classes provide for one asset class containing multiple product types in order to meet the objectives of a role such as market risk management. The traditional asset classes generally have one product type mapped to one asset class that in scenarios of market fluctuations leads to sudden erosion of funds especially in case of downside market conditions. For example, in case of a traditional asset class structure, the equity based asset class only contains equity related product types such as mutual funds and stocks. In case of market fluctuations, the value of the investments parked under equity based asset class fluctuates thus destabilizing the investment goals of the client. The traditional asset class structures are primarily structured to either grow investments or conserve or protect the investments. However, the asset class structures are never structured to manage the factors that impact the performance of the asset class structure. The factors in this case are nothing but the roles such as income production, inflation hedging, capital growth, and risk management. Thus, the present method and system focuses on developing an asset class structure that includes a role based asset class structure which provides for attainment of investment goals by better management of above-mentioned factors. The defined method and system not only focuses on growth of invested funds but also focuses on better management of factors impacting the performance of asset class structures.

In one embodiment, the provided automated recommendations and suggestions relating to retirement portfolio options to better manage each of long term, medium term and near term risk return investments can be assessed by the operator of the asset class structure generator system 100. In one embodiment, the operator is a financial advisor, wealth manager, financial organization or client planning for retirement.

The asset allocation modeler instruction(s) 434, which when executed by the processor(s) 420 actuates the asset allocation modeler server(s) 491 to identify the mix of roles for each of the portfolio option generated by the portfolio creator instruction(s) 435. The identification of role mix is nothing but percentage distribution of client's funds into each of defined roles.

The asset allocation modeler instruction(s) 434, which when executed by the processor(s) 420 actuates the asset allocation modeler server(s) to perform percentage distribution of client's retirement funds under each role. The percentage distribution of funds primarily depends upon including but not limited to the target periodic distribution rate and the evaluated client profile data.

The asset allocation modeler instruction(s) 434, which when executed by the processor(s) 420 actuates the asset allocation modeler server(s) 491 to identify role mix for at least one portfolio option generated to manage each of long term, medium term and near term risk return investments. The portfolio option for managing long term risk return investments includes more of investments into including but not limited to capital growth asset class (0%-35%), income production asset class (0%-40%), risk management asset class (0%-35%) and inflation hedging asset class (0%-35%). The percentage distribution of funds into individual role based asset classes of the long term retirement portfolio depends on the expected investment return target, volatility target, and distribution yield target. The retirement portfolio option for medium term risk return investments includes more of investments into including but not limited to capital growth asset class (0%-20%), income production asset class (0%-50%), risk management asset class (0%-45%) and inflation hedging asset class (0%-25%). The percentage distribution of funds into individual role based asset classes of the medium term retirement portfolio option depends on the expected investment return target, volatility target, and distribution yield target. The retirement portfolio option for managing near term risk return investments includes more of investments into including but not limited to risk management asset class (0%-50%) and inflation hedging asset class (0%-50%) such as checking account, savings account, certificate deposits, and money market funds. The portfolio for managing near term risk return investments is set up to meet the immediate needs of funds of a client. For example, in case the client is in need of funds and wants to withdraw funds from his/her portfolio, the system and method firstly provides for withdrawal of funds from the near term retirement portfolio option. The funds are transferred from long term/medium term retirement portfolios to near term retirement portfolio on need basis to maintain immediate availability of funds and secure the funds from sudden erosion or market fluctuations. In another embodiment, the time period or number of years to be defined as long term, medium term and near term, is determined by the data reader 110 of system 100 based on the inputs received from the client.

The portfolio creator instruction(s) 435, which when executed by the processor(s) 420 actuates the portfolio creator server(s) 492 to generate at least one portfolio option devised on the new role based asset class structure to better manage each of long term, medium term and near term risk return investments.

The asset allocation modeler instruction(s) 434, which when executed by the processor(s) 420 actuates the asset allocation modeler server(s) 491 to identify the product types that would be part of each of the role based asset class forming part of the role based asset class structure. The asset allocation modeler instruction(s) 434, which when executed by the processor(s) 420 actuates the asset allocation modeler server(s) 491 to map the product types to each of the role based asset classes. These roles include but need not be limited to capital growth, inflation hedging, risk management and income production. The role of the capital growth asset class within the portfolio is to grow capital through dividend increases and asset price appreciation. In one embodiment, domestic and international equity based products such as stocks are part of capital growth asset class. Capital growth asset class primarily houses product types that are more reactive to market fluctuations and provide for long term growth to client investments. Product types tagged to the role of inflation hedging have built-in mechanisms to protect against unexpected inflation. These can include but not limited to investments that have contractual terms that mandate increases in asset values and/or cash flows tied to inflation measures (such as inflation protected bonds, infrastructure, or real estate investments), product types that usually rise in value when inflation occurs (commodities or precious metals), or product types that increase with short-term′ interest rates, which generally rise when inflation increases (floating rate bank loans). In one embodiment, equities can also be considered for inflation hedging over the long-term, as corporate earnings increase over time. Over the short-term, though, the link between inflation and equity prices can be weak. These product types provide for security from the risk of outliving your investments. Product types mapped to the role of income production are used in the portfolio to generate current income including but not limited to interest payments, dividends, or other structured payments (like premiums received from selling call options in a covered call strategy). In one embodiment, the best income production product type would generate high levels of predictable income, which would not vary across market environments. Product types that help the clients limit their market risk are tagged with the role of risk management. Such product types would include but need not be limited to assets that hold their value regardless of the market environment (such as savings account, current account, certificate deposits, and debt bonds among others); assets that generally remain stable in value when other parts of the portfolio are declining (such as long-term government bonds, volatility-linked strategies, and managed futures) and assets that introduce uncorrelated sources of return and increase portfolio diversification (such as hedge funds).

The asset allocation modeler instruction(s) 434, which when executed by the processor(s) 420 actuates the asset allocation modeler server(s) 491 to evaluate the product types and rates each product type on a risk scale of one (1) to ten (10) with one being the lowest and ten being the highest. Other scale increments and boundaries may be substituted for risk assessment of the product types. In one embodiment, the measuring unit to evaluate the risk of each product type can be alpha numeric, alphabetic and the like. The percentage allocation of funds into individual product types depends on the rating provided by the risk scale for the various product types. The risk scale is defined by parameters that include, but need not be limited to, return on investment of a product type for a specific time period, sustainability of a particular product type under dynamic market scenarios, and/or amount of volatility experienced by the various product types in a defined time period. The performance of a particular product type for a specific time period is determined based on the relative comparison of that particular product type with the rest of the product types forming part of an asset class. The performance can be ascertained on rate of return on the invested amount, keeping in check the relative product type volatility, and/or sustainability of a particular product type during dynamic market conditions. For example, product type A provides ten percent (10%) annual rate of return on a given amount of $1,000, and product type B provides eight-and-a-half percent (8.5%) annual rate of return; however, in the last year, product type A has experienced more volatility in comparison to product type B; moreover, product type B has experienced more sustainability during the given time period than product type A. Therefore, the risk scale based on comprehensive interrelated analysis of mentioned parameters formulates a rating of seven (7) to product type B and a rating of six (6) to product type A. Since, product type B has a better risk scale rating of seven (7) and provides for less financial risk for the client, therefore, more client funds are allocated to product type B in comparison to product type A.

In one embodiment, U.S. large cap equities have multiple roles to play but may not be tagged to some roles at all. U.S. large cap equities can be a part of income production asset class, capital growth asset class and to some extent inflation hedging asset class but the same cannot be tagged to the role of risk management asset class. Similarly, in one embodiment, cash, savings account, current account, certificate deposits, and debt bonds have multiple roles to play but may not be tagged to some roles at all. Savings account, current account, certificate deposits, and debt bonds cash can play a role in risk management and to some extent it can be part of inflation hedging asset class and income production asset class but the same cannot be tagged to the role of capital growth asset class.

The asset allocation modeler instruction(s) 434, which when executed by the processor(s) 420 actuates the asset allocation modeler server(s) 491 to identify the individual products in which the client funds are to be allocated as part of a particular role and product type. In an exemplary scenario, a long term portfolio option based on the role based asset allocation model has forty five percent of the allocated fifty percent of funds allocated under capital growth, twenty five percent of the allocated fifty percent of funds allocated under inflation hedging, and twenty percent of the allocated fifty percent of funds allocated under market risk management. In one embodiment, the asset allocation modeler instruction(s) 434, which when executed by the processor(s) 420, allows for identification of product types under each of the roles. In one embodiment, forty five percent of the funds under capital growth asset class are invested into derivatives, options, mutual funds, direct stocks and the like. In one embodiment, the asset allocation modeler instruction(s) 434, which when executed by the processor(s) 420, further allows for identification of individual products under each product type such as mutual funds. In one embodiment, the method and system is connected to the systems and networks of various broker dealers, financial product based companies such as Morgan Stanley, River Source, Lincoln Financial and the like. The asset allocation modeler instruction(s) 434, which when executed by the processor(s) 420 thus firstly provides for defining the percentage distribution of funds under each role, secondly identifies individual product types and lastly identifies respective products into which the client's funds are to be invested.

The system simulator instruction(s) 436, of the asset class structure generator system 100 actuates the system simulator server(s) 493 to test the performance of at least one portfolio option generated by the portfolio creator 130. The performance of the portfolio is assessed based on varying parameters which include but are not limited to age, marital status, gender of the contract holder, and those of the beneficiary, details relating to the assets and liabilities, information relating to the number of dependents, financial goals, and their priority in terms of dollar value and timing, anticipated expenses, anticipated income, anticipated large expenditures such as educational expenses, buying a house, annual travel budget, account beginning balance, retirement start date, rate of inflation, preferred retirement income distribution strategy, periodic distribution rate, average annualized return from investment and variation in inflation.

In one embodiment, the system simulator 140, tests the performance of at least one portfolio option generated for long term, medium term, and near term. Based on the results of the simulation and considering the current market situation, the system simulator instruction(s) 436 provides for selection of at least one portfolio option for each of long term, medium term and near term.

In one embodiment, the data reader instruction(s) 433 actuates capturing by the data reader 110, if there is a fluctuation in the initial value of parameters which include but are not limited to age, marital status, gender of the contract holder, and those of the beneficiary, details relating to the assets and liabilities, information relating to the number of dependents, financial goals, and their priority in terms of dollar value and timing, anticipated expenses, anticipated income, anticipated large expenditures such as educational expenses, buying a house, annual travel budget, account beginning balance, retirement start date, rate of inflation, preferred retirement income distribution strategy, periodic distribution rate, average annualized return from investment and variation in inflation. The data reader instruction(s) 433 also actuates capturing by data reader 110, any substantial erosion in the achieved fund value of the client's long term, medium term and immediate term risk return portfolio. The data reader 110 seeks for the percentage threshold value in respect of decline in fund value of client's various portfolio investments.

In one embodiment, the client continues with the current portfolio if there is no change in the initial value of parameters which include but are not limited to age, marital status, gender of the contract holder, and those of the beneficiary, details relating to the assets and liabilities, information relating to the number of dependents, financial goals, and their priority in terms of dollar value and timing, anticipated expenses, anticipated income, anticipated large expenditures such as educational expenses, buying a house, annual travel budget, account beginning balance, retirement start date, rate of inflation, preferred retirement income distribution strategy, periodic distribution rate, average annualized return from investment and variation in inflation.

In one embodiment, if there is a fluctuation in the initial value of parameters which include but are not limited to age, marital status, gender of the contract holder, and those of the beneficiary, details relating to the assets and liabilities, information relating to the number of dependents, financial goals, and their priority in terms of dollar value and timing, anticipated expenses, anticipated income, anticipated large expenditures such as educational expenses, buying a house, annual travel budget, account beginning balance, retirement start date, rate of inflation, preferred retirement income distribution strategy, periodic distribution rate, average annualized return from investment and variation in inflation, the system simulator instruction(s) 436 actuates the system simulator server(s) 493 to assess the impact of change on each of the long term, medium term and near term portfolio. The system simulator instruction(s) 436 also actuates assessment by the system simulator server(s) 493, if with the change in parameters, market conditions and the like, the current percentage distribution of client funds into the long term, medium term and near term portfolio option is able to service the periodic distribution rate. If with all the changes, the existing percentage distribution of client funds is not able to service the periodic distribution rate, then the client funds from initial long term and/or medium term portfolio is transferred to near term portfolio. If with all the changes, the existing percentage distribution of client funds is able to service the periodic distribution rate, then there is no change executed to the existing role based asset class structure and thereby no change to either the product type or individual products

In one embodiment, the system simulator instruction(s) 436 actuates reassessment by the system simulator server(s) 493 to check if with the transfer of client funds within at least two of the three portfolios is able to provide for servicing of the periodic distribution rate. If the reassessment leads to non-servicing of periodic distribution rate then the system simulator instruction(s) 436 actuates the asset allocation modeler server(s) 491 to affect changes into asset class structure, selected product type and/or product.

In one embodiment, the client is an individual or natural person planning for investments and or retirement.

The communication interfaces 470 are an example of communication media. Communication media include wired media such as a wired network or direct-wired connection, and wireless media, such as acoustic, radio frequency (RF), infrared and other wireless media. It will be appreciated that not all of the components or devices illustrated in FIG. 4 or otherwise described in the previous paragraphs are necessary to support embodiments as herein described.

In one embodiment, the computing system 400 has been designed in a way that enables each instruction module within the electronic device 410 to run independently on need basis rather than always executing all the instructions in a particular flow or series. This will allow faster processing of the computing system 400.

In one embodiment, the processing of the instruction module(s) is carried out by computing system 400. The automated operational steps of the retirement plan generator system can be implemented on any electronic device including but not limited to low end cellular devices, pagers, smartphones, computers, servers, and or any other device having processing, receiving and transmitting capabilities.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Accordingly, the disclosure and the figures are to be regarded as illustrative rather than restrictive.

Those skilled in the art would further appreciate that the various illustrative logical blocks, configurations, modules, and process or instruction steps described in connection with the embodiments disclosed herein may be implemented as electronic hardware, system software, or combinations of both. Various illustrative components, blocks, configurations, modules, or steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The steps of the method described in connection with the embodiments disclosed herein may be embodied directly in hardware, in a software module executed by a processor, or in a combination of the two. A software module may reside in system readable media, such as random access memory (RAM), read only memory (ROM), registers, a hard disk, a removable disk, a CD-ROM, or any other form of storage medium. An exemplary storage medium is coupled to the processor such that the processor can read information from, and write information to, the storage medium. In the alternative, the storage medium may be integral to the processor or the processor and the storage medium may reside as discrete components in a device or system.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments.

The system and method disclosed herein contemplate uses in association with web services, utility computing, pervasive and individualized computing, security and identity solutions, autonomic computing, commodity computing, mobility and wireless solutions, open source, biometrics, grid computing and/or mesh computing.

Any databases/data sources discussed herein may include relational, hierarchical, graphical, or object-oriented structure and/or any other database configurations. The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

The computing unit of the web contract holder may be further equipped with an Internet browser connected to the Internet or an intranet using standard dial-up, cable, DSL or any other Internet protocol known in the art. Transactions originating at a web contract holder may pass through a firewall in order to prevent unauthorized access from users of other networks.

Firewall may include any hardware and/or software suitably configured to protect components and/or enterprise computing resources from users of other networks. Further, a firewall may be configured to limit or restrict access to various systems and components behind the firewall for web contract holders connecting through a web server. Firewall may reside in varying configurations including state full inspection, proxy based and packet filtering among others. Firewall may be integrated within a web server or any other components or may further reside as a separate entity.

The computing system 400 discussed herein may provide a suitable website or other internet-based graphical user interface which is accessible by users. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, Interbase, etc., may be used to provide an Active Data Object (ADO) compliant database management system.

In particular aspects, the disclosed systems and methods may be configured to generate an interactive graphical user interface (GUI). The GUI may be output by a display device of the computing system 400 or communicated to another device (e.g., a mobile device) associated with a user. In some examples of the computing system 400, the computing system 400 (or one or more components thereof) may be configured to generate a GUI that includes a representation of an overall investment portfolio. The overall investment portfolio may include a near term investment portfolio, a medium term investment term portfolio, and a long term investment portfolio. Each of the investment portfolios may include funds allocated to one or more asset classes, as described herein. The GUI may include graphical representations (e.g., charts, such as those shown in FIG. 3) indicating how the funds are allocated between the asset classes of the different investment portfolios.

Further, the GUI may include one or more interactive elements configured to receive user input. To illustrate, the computing system 400 may include a text entry box, a set of radio buttons, a set of check boxes, one or more slider elements, one or more drag and drop regions, or a combination thereof. The computing system 400 may detect an interaction with the one or more interactive elements indicating a change to an investment related parameter associated with the overall investment portfolio. Examples of investment related parameters include age, marital status, gender of the contract holder, and those of the beneficiary, details relating to the assets and liabilities, information relating to the number of dependents, financial goals, and their priority in terms of dollar value and timing, anticipated expenses, anticipated income, anticipated large expenditures such as educational expenses, buying a house, annual travel budget, account beginning balance, retirement start date, rate of inflation, preferred retirement income distribution strategy, periodic distribution rate, average annualized return from investment and variation in inflation. In response to identifying the change to the investment related parameter, the computing system 400 may initiate a change in the allocation of the funds between the near term investment portfolio, the medium term investment term portfolio, and the long term investment portfolio and/or adjust product types included in one or more asset classes therein.

To illustrate, the computing system 400 may automatically initiate one or more financial transactions at one or more devices associated with financial institutions. In some examples, the GUI may receive authentication information for financial accounts/institutions from the user, where such communication may be encrypted at the user's device and decrypted at the computing system 400. Encrypted/secured communication may also be used on a communication channel between the computing system 400 and the one or more devices associated with the financial institutions. Upon receiving confirmation from the one or more devices associated with the financial institutions that a transaction is completed, the computing system 400 may update the GUI to reflect changes to the overall investment portfolio and to the near term investment portfolio, the medium term investment term portfolio, and the long term investment portfolio. In some aspects, the computing system 400 may continuously or periodically monitor various markets to determine if and when to initiate financial transactions at the one or more devices associated with the financial institutions to maintain compliance with goals indicated by a user profile.

Alternatively, or in addition, financial transaction(s) may be automatically initiated by the computing system 400 in response to receiving updated (e.g., dynamic) information regarding relevant markets (e.g., equities, real estate, debt, etc.). Such information may be displayed on the GUI. The GUI may also be updated to reflect changes to the overall, near term, medium term, and/or long term investment portfolios upon receiving confirmation that the financial transaction(s) have been completed. Examples of financial transactions that may be initiated by the computing system 400 may include, but are not limited to buying, selling, trading, transferring funds, or a combination thereof.

In some implementations, the computing system 400 may determine a status (e.g., a monetary value, a gain, a loss, etc.) associated with the overall investment portfolio, the near term investment portfolio, the medium term investment term portfolio, the long term investment portfolio, or a combination thereof. Based on the status, the computing system 400 may assign the overall investment portfolio, the near term investment portfolio, the medium term investment term portfolio, the long term investment portfolio, or a combination thereof to particular personnel (e.g., a particular financial advisor, retirement planner, etc.) having relevant experience. To illustrate, the computing system 400 may include, or may have access to, a database that includes information regarding education, experience, and clients of various advisors/planners. Based on the information in the database, the computing system 400 may identify a particular advisor/planner that is suitable for a particular user. The computing system 400 may transmit an indication to a device associated with the particular advisor/planner. The indication may notify the advisor/planner that he or she has been assigned to the overall investment portfolio, the near term investment portfolio, the medium term investment term portfolio, the long term investment portfolio, or a combination thereof. The computing system 400 may further receive feedback from the device associated with the advisor/planner. In response to receiving the feedback, the computing system 400 may update the GUI to display advice indicated by the feedback. In addition or in the alternative, the computing system 400 may, in response to the feedback, initiate one or more financial transactions at one or more devices associated with financial institutions in order to change the allocation of the funds between the near term investment portfolio, the medium term investment term portfolio, and the long term investment portfolio and/or adjust product types included in one or more asset classes of the near term investment portfolio, the medium term investment term portfolio, and the long term investment portfolio. Alternatively, or in addition, the computing system 400 may facilitate communication (e.g., audio, video, and or textual communication) between the device associated with the advisor/planner and a device associated with the user.

It will thus be appreciated that the computing system 400, as described above, may perform or may enable investment according to a process that was not previously performed by humans with or without aid from computers. Accordingly, the computing system 400 and the techniques of the present disclosure do not merely automate previously known investment processes. To illustrate, the computing system 400 may invest funds of a portfolio into different role based asset classes. Such an asset class may include assets of more than one product type. Further, the computing system 400 may allocate funds of an overall investment portfolio between different investment portfolios within the overall investment portfolio. Each investment portfolio within the overall investment portfolio may be structured according to an asset allocation model associated with a goal of the investment portfolio. Allocating assets between different goal oriented investment portfolios, where each goal oriented investment portfolio is divided into role based asset classes may enable investors to achieve investment goals while accounting for market factors that may have been ignored by previous investing techniques. Therefore, the computing system 400 may represent a technology-based improvement to previous investing techniques.

Moreover, it will be appreciated that the computing system 400 and the techniques of the present disclosure may enable multiple additional technological benefits. For example, the computing system 400 may enable faster achievement of a desired investment goal while keeping a user apprised of developments via a GUI, notifications, etc. To illustrate, in a market downturn, an owner of a stock portfolio that does not have the benefit of the described asset class structures may be limited to manually allocating between stocks in different industry sectors. In contrast, a portfolio organized as described herein may be automatically rebalanced to fulfill its assigned role with multiple available product types in each asset class (e.g., the ability to short stocks in an industry sector experiencing a downturn while simultaneously acquiring non-equity assets predicted to appreciate). By virtue of having multiple product types to choose from in a given class, the described techniques may achieve investment objectives faster. As another example, the computing system 400 may enable greater flexibility in configuring portfolios. To illustrate, multiple product types may be included in a role based asset class, certain product types may be included in more than one role based asset class, and various heterogenous goal based sub portfolios may be constructed based on the asset classes. This improved flexibility may enable a more robust ability to adjust to different market conditions and achieve a user's stated goals (e.g., as indicated in the user's profile data).

Any of the communications, inputs, database, databases or displays discussed herein may be facilitated through a website having web pages. The term “web page” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML, cascading style sheets (CSS), helper applications, plug-ins, and the like.

A server may include a web service that receives a request from a web server, the request including a URL and an IP address. The web server retrieves the appropriate web pages and sends the data or applications for the web pages to the IP address. Web services are applications that are capable of interacting with other applications over a communications means, such as the internet. Web services are typically based on standards or protocols such as XML, SOAP, WSDL and UDDI. Web services methods are well known in the art, and are covered in many standard texts. See, e.g., Alex Nghiem, IT Web Services: A Roadmap for the Enterprise (2003), hereby incorporated by reference.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, Macromedia Cold Fusion, Microsoft Active Server Pages, Java, COBOL, assembler, PERL, Visual Basic, SQL Stored Procedures, extensible markup language (XML), with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a contract holder-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

As will be appreciated by one of ordinary skill in the art, the system and method disclosed herein may be embodied as a customization of an existing system, an add-on product, upgraded software, a standalone system, a distributed system, a method, a data processing system, a device for data processing, and/or a computer program product. Accordingly, the system may take the form of an entirely software embodiment, an entirely hardware embodiment, or an embodiment combining aspects of both software and hardware. Furthermore, the system may take the form of a computer program product on a computer-readable database medium having computer-readable program code means embodied in the database medium. Any suitable computer-readable database medium may be utilized, including hard disks, CD-ROM, optical database devices, magnetic database devices, and/or the like.

The system and method is described herein with reference to screen shots, block diagrams and flowchart illustrations of methods, apparatus (e.g., systems), and computer program products according to exemplary embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, web pages, websites, web forms, prompts, etc. Practitioners will appreciate that the illustrated steps described herein may comprise in any number of configurations including the use of windows, web pages, web forms, popup windows, prompts and the like. It should be further appreciated that the multiple steps as illustrated and described may be combined into single web pages and/or windows but have been expanded for the sake of simplicity. In other cases, steps illustrated and described as single process steps may be separated into multiple web pages and/or windows but have been combined for simplicity.

Finally, it should be understood that various principles of the invention have been described in illustrative embodiments. However, many combinations and modifications of the above-described components, used in the practice of the invention, in addition to those not specifically described, may be varied and particularly adapted to specific environments and operating requirements without departing from those principles. Other variations and modifications of the present invention will be apparent to those of ordinary skill in the art, and it is the intent that such variations and modifications be covered.

Benefits, other advantages, and solutions to problems have been described herein with regard to specific embodiments. However, the benefits, advantages, solutions to problems, and any element(s) that may cause any benefit, advantage, or solution to occur or become more pronounced are not to be construed as critical, required, or essential features or elements of any or all the claims or the invention. It should be understood that the detailed description and specific examples, indicating exemplary embodiments of the invention, are given for purposes of illustration only and not as limitations. Many changes and modifications within the scope of the instant invention may be made without departing from the spirit thereof, and the invention includes all such modifications. Corresponding structures, materials, acts, and equivalents of all elements in the claims below are intended to include any structure, material, or acts for performing the functions in combination with other claim elements as specifically claimed. The scope of the invention should be determined by the appended claims and their legal equivalents, rather than by the examples given above. Reference to an element in the singular is not intended to mean “one and only one” unless explicitly so stated, but rather “one or more.” Moreover, where a phrase similar to “at least one of A, B, and C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

What is claimed is:

1. An apparatus comprising:
a processor;
a network interface;
a display device;
a memory storing instructions that, when executed by the processor, cause the processor to perform operations comprising:
based on profile data received via the network interface, generating a portfolio data structure, the portfolio data structure identifying a plurality of asset classes and an allocation of funds between the asset classes, wherein a particular asset class of the plurality of asset classes includes a first product of a first product type and a second product of a second product type;
based on the portfolio data structure, sending a message, via the network interface, to initiate a transaction at a device associated with a financial institution; and
initiating display of a graphical user interface at the display device based on the portfolio data structure.

2. The apparatus of claim 1, further comprising an input device configured to receive input, wherein the operations further include:
generating a modified portfolio data structure based on the portfolio data structure and the input;
based on the modified portfolio data structure, sending a second message, via the network interface, to initiate a second transaction at the device associated with the financial institution; and
initiating display of an updated graphical user interface at the display device based on the modified portfolio data structure.

3. An asset class structure generator system implemented method comprising:
extracting from at least one data reader server client profile data from at least one database, and
generating from at least one data reader server at least one periodic distribution rate;
generating, from at least one asset allocation server, a role based asset class structure, wherein at least one asset class is coupled to at least one role, and wherein the role comprises at least one of capital growth, inflation hedging, risk management, or income production;
generating from at least one portfolio creator server, at least a first role based portfolio option to manage long term investments, at least a second role based portfolio option to manage medium term investments, and at least a third role based portfolio option to manage near term investments; and
simulating, by a system simulator, performance of at least one role based portfolio option, wherein the performance of at least one portfolio is assessed based on changing at least one parameter.

4. The asset class structure generator system implemented method of claim 3, wherein the profile data includes but not limited to age, marital status, gender of the contract holder, and those of the beneficiary, details relating to the assets and liabilities, information relating to the number of dependents, financial goals, and their priority in terms of dollar value and timing, anticipated expenses, anticipated income, anticipated large expenditures such as educational expenses, buying a house, annual travel budget, account beginning balance, retirement start date, rate of inflation, preferred retirement income distribution strategy, projected expenses and the like.

5. The asset class structure generator system implemented method of claim 3, wherein the periodic distribution rate is extracted from a distribution rate table, wherein the distribution rate table comprises of at least one distribution rate, and wherein at least one distribution rate is computed based on the parameters including but not limited to expected distribution rate, inflation rate, distribution strategy, expected retirement period, wrap fee, and risk tolerance.

6. The asset class structure generator system implemented method of claim 3, wherein at least one product type is rated for at least one defined role.

7. The asset class structure generator system implemented method of claim 3, wherein the product type is part of more than one role based asset class, and wherein the product type is selected for a role defined asset class based on the rating received for the defined role.

8. The asset class structure generator system implemented method of claim 3, wherein the first role based portfolio option to manage long term investments has a role mix including but not limited to capital growth, inflation hedging, risk management, and income production.

9. The asset class structure generator system implemented method of claim 3, wherein the first role based portfolio option to manage long term investments has a role mix including but not limited to 5%-55% of allocated funds under capital growth, 5%-35% of allocated funds under inflation hedging, 15%-35% of allocated funds under risk management, and 5%-45% of allocated funds under income production.

10. The asset class structure generator system implemented method of claim 3, wherein the second role based portfolio option to manage medium term investments has a role mix including but not limited to capital growth, inflation hedging, risk management, and income production.

11. The asset class structure generator system implemented method of claim 3, wherein the second role based portfolio option to manage medium term investments has a role mix including but not limited to 0%-20% of allocated funds under capital growth, 5%-25% of allocated funds under inflation hedging, 15%-45% to allocated funds under risk management, and 15%-50% to allocated funds under income production.

12. The asset class structure generator system implemented method of claim 3, wherein the third role based portfolio option to manage near term investments has a role mix including but not limited to capital growth, inflation hedging, risk management, and income production.

13. The asset class structure generator system implemented method of claim 3, wherein the third role based portfolio option to manage near term investments has a role mix including but not limited to 5%-20% of allocated funds under capital growth, 5%-25% of allocated funds under inflation hedging, 5%-35% of allocated funds under risk management, and 35%-85% of allocated funds under income production.

14. The asset class structure generator system implemented method of claim 3, wherein the parameters which include but are not limited to age, marital status, gender of the contract holder, and those of the beneficiary, details relating to the assets and liabilities, information relating to the number of dependents, financial goals, and their priority in terms of dollar value and timing, anticipated expenses, anticipated income, anticipated large expenditures such as educational expenses, buying a house, annual travel budget, account beginning balance, retirement start date, rate of inflation, preferred retirement income distribution strategy, periodic distribution rate, average annualized return from investment and variation in inflation.

15. The asset class structure generator system implemented method of claim 3, wherein the investment mix of at least one role based portfolio option is changed by transferring investments from third and/or second role based portfolio option to the second and/or first role based portfolio option.

16. A asset class structure generator system comprising:
a data reader, for extracting client profile data from at least one database, wherein the data reader generates at least one periodic distribution rate;
an asset allocation modeler, for generating a role based asset class structure, wherein at least one asset class is coupled to at least one role, and wherein the role may include but not limited to capital growth, inflation hedging, risk management, and income production;
a portfolio creator, for generating at least a first role based portfolio option to manage long term investments, at least a second role based portfolio option to manage medium term investments, and at least a third role based portfolio option to manage near term investments; and
a system simulator, for simulating performance of at least one role based portfolio option, wherein the performance of at least one portfolio is assessed based on changing at least one parameter.

17. The asset class structure generator system of claim 16, wherein the data reader extracts profile data including but not limited to age, marital status, gender of the contract holder, and those of the beneficiary, details relating to the assets and liabilities, information relating to the number of dependents, financial goals, and their priority in terms of dollar value and timing, anticipated expenses, anticipated income, anticipated large expenditures such as educational expenses, buying a house, annual travel budget, account beginning balance, retirement start date, rate of inflation, preferred retirement income distribution strategy, projected expenses and the like.

18. The asset class structure generator system of claim 16, wherein the data reader extracts the periodic distribution rate from a distribution rate table, wherein, the distribution rate table comprises of at least one periodic distribution rate, and wherein at least one periodic distribution rate is computed based on the parameters including but not limited to expected distribution rate, inflation rate, distribution strategy, expected retirement period, wrap fee, and risk tolerance.

19. The asset class structure generator system of claim 16, wherein at least one product type is rated for at least one defined role.

20. The asset class structure generator system of claim 16, wherein the product type is part of more than one role based asset class, and wherein the product type is selected for a role defined asset class based on the rating received for the defined role.
